(19) United States
(12) Patent Application Publication
(10) Pub. No.: US 2025/0174203 A1
(43) Pub. Date: May 29, 2025

(54) SOURCE DRIVER, DISPLAY DRIVING DEVICE, AND DISPLAY DEVICE INCLUDING THE DISPLAY DRIVING DEVICE

(71) Applicant: SAMSUNG ELECTRONICS CO., LTD., Suwon-si (KR)

(72) Inventors: Kyungjik MIN, Suwon-si (KR); Jeeyeon EOM, Suwon-si (KR)

(73) Assignee: SAMSUNG ELECTRONICS CO., LTD., Suwon-si (KR)

(21) Appl. No.: 18/937,255

(22) Filed: Nov. 5, 2024

(30) Foreign Application Priority Data
Nov. 28, 2023 (KR) 10-2023-0167884
May 7, 2024 (KR) 10-2024-0060020

(51) Int. Cl. G09G 3/3275; G09G 3/00; G09G 3/3233; G09G 3/36

(52) U.S. Cl. CPC G09G 3/3275; G09G 3/006; G09G 3/3688; G09G 3/3233; G09G 3/3696; G09G 2310/027; G09G 2310/0291; G09G 2310/0297; G09G 2330/12

(57) ABSTRACT

A display driving device according to one or more example embodiments includes a source driver configured to output a data signal obtained by amplifying an input signal to a source line in a first period, and in a second period different from the first period, receive a detection signal from the source line and output a comparison result signal based on a comparison between the detection signal and the input signal; and a driving controller configured to determine a characteristic of the source line based on a timing at which a level of the comparison result signal transitions in the second period.

### CROSS-REFERENCE TO RELATED APPLICATIONS

This application is based on and claims priority from Korean Patent Application No. 10-2023-0167884, filed on Nov. 28, 2023 in the Korean Intellectual Property Office, and Korean Patent Application No. 10-2024-0060020 filed on May 7, 2024 in the Korean Intellectual Property Office, the disclosures of which are herein incorporated by reference in their entireties.

### BACKGROUND

### 1. Field

One or more example embodiments of the disclosure relate to a source driver, a display driving device, and a display device including the display driving device.

### 2. Description of Related Art

In general, a display panel displays images and provides various visual information to users. The display panel includes a plurality of pixels, and each of the plurality of pixels expresses light of a predetermined luminance to display an image. A display driver integrated circuit (DDI) may be used to drive the plurality of pixels.

Since the characteristics of the display panel are different depending on a process distribution, the DDI, which provides multiple signals to the display panel, is driven with high electric power to overcome the differences in the characteristics between the display panels.

### SUMMARY

One or more example embodiments of the disclosure provide a source driver, a display driving device, and a display device including the display driving device, in which a characteristics of a pixel and/or a display panel may be determined without using a separate amplifier.

One or more example embodiments of the disclosure provide a source driver, a display driving device, and a display device including the display driving device, in which a defect in a display panel may be detected.

According to an aspect of an example embodiment of the disclosure, a display driving device is provided. The display driving device includes a source driver configured to output a data signal obtained by amplifying an input signal to a source line in a first period, and in a second period different from the first period, receive a detection signal from the source line and output a comparison result signal based on a comparison between the detection signal and the input signal; and a driving controller configured to determine a characteristic of the source line based on a timing at which a level of the comparison result signal transitions in the second period.

According to an aspect of an example embodiment of the disclosure, a display driving device is provided. The display driving device includes a panel including a plurality of pixels and a plurality of source lines connected to the plurality of pixels; and a display driving circuit including an amplifier region and a driving controller, the amplifier region comprising an amplifier and being configured to transmit a plurality of data signals to the plurality of source lines in a first period, and in a second period different from the first period, receive a plurality of detection signals from the plurality of source lines and output a plurality of comparison result signals by comparing the plurality of detection signals and an input signal, and the driving controller being configured to determine characteristics of the plurality of source lines based on the plurality of comparison result signals, respectively.

According to an aspect of an example embodiment of the disclosure, a source driver is provided. The source driver includes a digital-to-analog converter configured to output an input signal based on input data; an amplifier region including an amplifier, the amplifier region being configured to amplify the input signal to output a data signal in a first period, and in a second period after the first period, compare the input signal and a detection signal received from a source line to output a comparison result signal; and a switch circuit configured to, based on a level of a first selection signal, selectively connect an output terminal of the amplifier region to the source line in the first period and selectively disconnect the output terminal of the amplifier region from the source line in the second period.

### BRIEF DESCRIPTION OF DRAWINGS

The above and other aspects, features, and advantages of certain example embodiments of the disclosure may be more apparent from the following description taken in conjunction with the accompanying drawings, in which:

FIG. 1 is an example block diagram of a display device according to one or more example embodiments.

FIG. 2 is a block diagram showing a part of a panel and a source driver according to one or more example embodiments.

FIG. 3 and FIG. 4 are views that illustratively show a part of a panel and a source driver according to one or more example embodiments.

FIG. 5 is a timing diagram of an operation of detecting a characteristic of a source line by a source driver according to one or more example embodiments.

FIG. 6 and FIG. 7 are timing diagrams of an operation of detecting a defect in a source line by a source driver according to one or more example embodiments.

FIG. 8 is a timing diagram of an operation of detecting a defect in a source line by a source driver according to one or more example embodiments.

FIG. 9 is a block diagram showing a part of a panel and a source driver according to one or more example embodiments.

FIG. 10 and FIG. 11 are views that illustratively show a part of a panel and a source driver according to one or more example embodiments.

FIG. 12 is a timing diagram of an operation of determining a characteristic of a source line by a source driver according to one or more example embodiments.

FIG. 13 is a block diagram showing a connection relationship between a plurality of source lines and a source driver of a pixel array according to one or more example embodiments.

FIG. 14 is a view to explain a display system according to one or more example embodiments.

FIG. 15 is a view to explain a display system according to one or more example embodiments.

### DETAILED DESCRIPTION

The following description with reference to the accompanying drawings is provided to assist in a comprehensive understanding of example embodiments of the disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element. Reference throughout the disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments herein may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). Hereinafter, various embodiments of the disclosure are described with reference to the accompanying drawings.

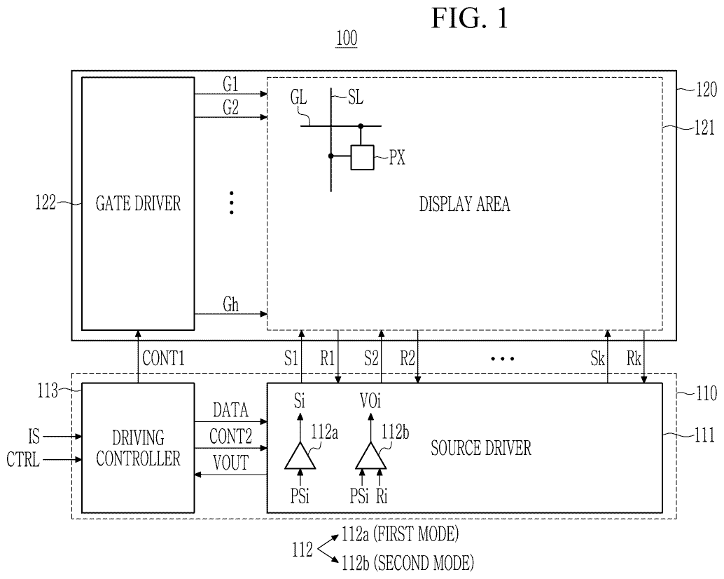

FIG. 1 is an example block diagram of a display device according to one or more example embodiments.

Referring to FIG. 1, a display device 100 according to one or more example embodiments may include a driving circuit 110 and a panel 120. In some embodiments, the display device 100 may further include a power supply circuit such as a DC-to-DC converter that provides a driving voltage to the driving circuit 110 and the panel 120. A display driving device according to one or more example embodiments may correspond to the driving circuit 110.

The panel 120 may include a display area 121 where an image is displayed and a gate driver 122 that outputs a driving signal to the display area 121. In some embodiments, the gate driver 122 may be included in the driving circuit 110. In an embodiment, a source line SL, a gate line GL, and a pixel PX may be positioned in the display area 121.

In the display area 121, the plurality of pixel PX may be positioned to display an image. The pixel PX may be connected to a corresponding source line SL among a plurality of source lines and a corresponding gate line GL among a plurality of gate lines. The pixel PX may receive a data signal input through the source line SL when a gate signal is supplied to the gate line GL. The pixel PX may express light of a predetermined luminance corresponding to the input data signal. The plurality of pixel PX may display the image as one frame unit.

When the display device 100 is an organic light emitting display device, each of the pixels PX may include a plurality of transistors including a driving transistor and an organic light-emitting diode. The driving transistor included in the pixel PX may supply a current corresponding to the data signal to the organic light-emitting diode, and based thereon, the organic light-emitting diode may emit light with a predetermined luminance. When the display device 100 is a liquid crystal display device, each of the pixels PX may include a switching transistor and a liquid crystal capacitor. The pixel PX may control a supply of light of a predetermined luminance to an outside by controlling a transmittance of a liquid crystal in response to the data signal.

In FIG. 1, the pixel PX is shown as being connected to one source line SL and one gate line GL, but a connection structure of a signal line of the pixel PX of the display device according to one or more example embodiments is not limited thereto. For example, various signal lines may be additionally connected according to a circuit structure of the pixel PX. In an embodiment, the pixel PX may be implemented in various currently known forms.

The gate driver 122 may provide a plurality of gate signals G1, G2, . . . , Gh. The plurality of gate signals G1, G2, . . . , Gh may be a pulse signal with an enable level and a disable level. The plurality of gate signals G1, G2, . . . , Gh may be respectively applied to the plurality of gate lines GL. When a gate signal of the enable level is applied to the gate line GL connected to the pixel PX, the data signal applied to the source line SL connected to the pixel PX may be transmitted to the pixel PX. The gate driver 122 may provide the plurality of gate signals G1, G2, . . . , Gh during a plurality of horizontal periods. One frame may include the plurality of horizontal periods.

In FIG. 1, the gate driver 122 is shown as being implemented on the same substrate as the panel 120 and positioned at a periphery of the panel 120, but the gate driver 122 may be implemented as a separate semiconductor die, chip, or module and connected to the panel 120. Additionally, a part of the gate driver 122 may be positioned in the panel 120 and the remaining part may be included in the driving circuit 110.

The driving circuit 110 may include a source driver 111 and a driving controller 113. Some or all of the source driver 111 and the driving controller 113 may be implemented as the same semiconductor die, chip, or module, or may be implemented as separate semiconductor dies, chips, or modules. In some embodiments, the source driver 111 may be implemented on the same substrate as the panel 120. In this case, the source driver 111 may be placed on the periphery of the panel 120.

The source driver 111 may receive a data DATA in a form of a digital signal from the driving controller 113 and convert the data DATA into data signals S1, S2, . . . , Sk in a form of an analog signal. Here, the data DATA may include a gray information corresponding to each pixel PX for displaying an image corresponding to an image signal IS on the panel 120. The source driver 111 may transmit the plurality of data signals S1, S2, . . . , Sk to the panel 120 according to a source driver control signal CONT2 provided from the driving controller 113. The source driver 111 may be referred to as a data driver.

In an embodiment, the source driver 111 may receive detection signals R1, R2, . . . , Rk from the plurality of source line SL. The source driver 111 may sense a potential of the plurality of source lines SL. The source driver 111 may compare the potential of the detection signals R1, R2, . . . , Rk with a reference voltage. The source driver 111 may provide a comparison result of each of the detection signals R1, R2, . . . , Rk and the reference voltage to the driving controller 113. The source driver 111 may operate as a receiver.

In an embodiment, the source driver 111 may divide a time to output the data signals S1, S2, . . . , Sk or receive the detection signals R1, R2, . . . , Rk. In other words, the source driver 111 may output the data signals S1, S2, . . . , Sk within a first time period and receive the detection signals R1, R2, . . . , Rk within a second time period other than the first time period. For example, the source driver 111 may receive the detection signals R1, R2, . . . , Rk in a first section of a vertical blank period VBLANK within one frame, and output the data signals S1, S2, . . . , Sk in a second section other than the first section within one frame. The source driver 111 may receive the detection signals R1, R2, . . . . Rk in a first section of a horizontal blank period HBLANK within one horizontal period, and output data signals S1, S2, . . . Sk in a second section other than the first section within one horizontal period. The source driver 111 may output the data signals S1, S2, . . . , Sk in a first section of an active period within one horizontal period and receive the detection signals R1, R2, . . . , Rk in a second section other than the first section within one horizontal period.

The source driver 111 may be electrically connected to the plurality of source lines SL.

The source driver 111 may transmit the plurality of data signals S1, S2, . . . , Sk to the plurality of electrically connected source lines SL. The source driver 111 may receive the plurality of detection signals R1, R2, . . . , Rk from the plurality of electrically connected source lines SL.

The source driver 111 may include an amplifier region 112. In a first mode FIRST MODE in which the source driver 111 outputs the plurality of data signals S1, S2, . . . , Sk, an output terminal and an input terminal of an amplifier region 112a included in the amplifier region 112 may be electrically connected to a corresponding source line SL. The amplifier region 112 may transmit a corresponding data signal S1 among the plurality of data signals S1, S2, . . . , Sk to the corresponding source line SL

In the first mode FIRST MODE, the amplifier region 112 may operate as a unit gain amplifier. In a second mode SECOND MODE in which the source driver 111 receives the plurality of detection signals R1, R2, . . . , Rk, an output terminal of an amplifier region 112b included in the amplifier region 112 may be electrically disconnected from a corresponding source line SL. An input terminal of the amplifier region 112b may receive a corresponding detection signal Ri among the plurality of detection signals R1, R2, . . . , Rk from the corresponding source line SL. The amplifier region 112 may output a comparison result signal VOi. The amplifier region 112 may output the comparison result signal VOi to the driving controller 113. In the second mode SECOND MODE, the amplifier region 112 may operate as a comparator.

The driving controller 113 may receive the image signal IS and a driving control signal CTRL from a host device and based thereon, control the gate driver 122 and the source driver 111. Here, the host device may be a computing device or a system that controls, from an outside, the display device 100 to display a desired image (e.g., an image desired by a user) on the panel 120. The driving control signal CTRL provided from the host device may include control instructions and predetermined data for controlling the gate driver 122 and the source driver 111. The driving controller 113 may control the gate driver 122 and the source driver 111 based on the driving control signal CTRL. For example, the driving control signal CTRL may include a horizontal synchronizing signal HSYNC, a vertical synchronization signal VSYNC, a main clock signal MCLK, and a data enable signal DE. The driving controller 113 may generate the data DATA by dividing the image data IS into one frame unit based on the vertical synchronizing signal VSYNC, and dividing the image data IS for each gate line GL based on the horizontal synchronizing signal HSYNC. The driving controller 113 may transmit a gate driver control signal CONT1 and the driver control signal CONT2 to the gate driver 122 and the source driver 111, respectively, to perform a control that synchronizes operations of the source driver 111 and the gate driver 122, for example. When the source driver 111 receives the plurality of detection signals R1, R2, . . . , Rk, the driving controller 113 may control the source driver 111 such that the source driver 11 outputs a comparison result signal VOUT to the driving controller 113. The driving controller 113 may control the gate driver 122 and the source driver 111 based on a self-generated control instruction, separately from the driving control signal CTRL received from the host device or in addition to the driving control signal CTRL.

In an embodiment, the driving controller 113 may determine a characteristic of the source line SL based on the comparison result signal VOUT. That is, the driving controller 113 may detect a load of the source line SL and/or an occurrence of a short on the source line SL by using the comparison result signal VOUT. Specifically, the driving controller 113 may determine the load of the source line SL based on a level of the comparison result signal VOUT. For example, the driving controller 113 may determine a magnitude of the load of the source line SL based on a timing at which the level of the comparison result signal VOUT transitions. In some embodiments, the driving controller 113 may determine the load and/or the occurrence of a short circuit of the source line SL based on a value of the data DATA provided to the source driver by the driving controller 113 at a timing when the level of the comparison result signal VOUT transitions. In some embodiments, the driving controller 113 may count the timing at which the level of the comparison result signal VOUT transitions and determine the load of the source line SL and/or the occurrence of the short circuit in the source line SL based on a result of counting.

The source driver 111 of one or more example embodiments may detect the load of the source line SL and/or the occurrence of the short circuit in the source line SL. The source driver 111 of one or more example embodiments may transmit the data signal to the source line SL or receive the detection signal from the source line SL by using one amplifier region 112. Therefore, according to the driving circuit 110 of one or more example embodiments, an area occupied by the source driver 111 may be reduced, and a size of the driving circuit 110 may be reduced. Additionally, according to the driving circuit 110 of one or more example embodiments, since the load of the source line may be determined, an operating electric power of the source driver 111 may be reduced based on the load of the source line.

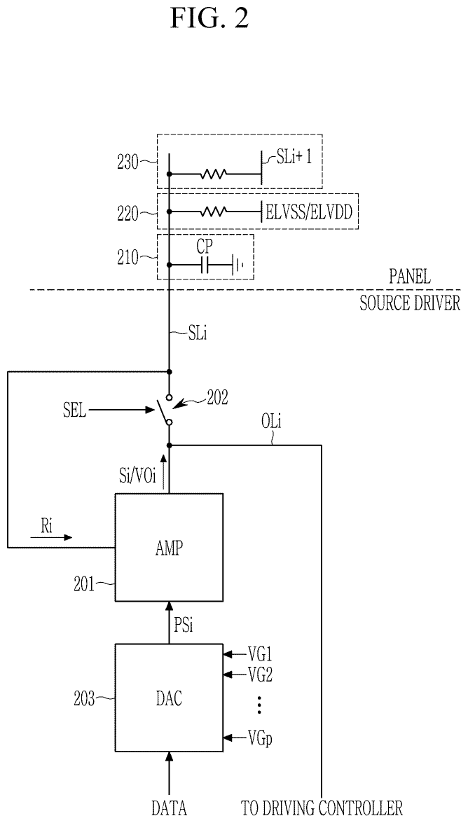

FIG. 2 is a block diagram showing a part of a panel and a source driver according to one or more example embodiments.

Referring to FIG. 2, the source driver SOURCE DRIVER includes an amplifier region 201, a switch circuit 202, and a digital-to-analog converter (DAC) 203. The source driver SOURCE DRIVER may be connected electrically and/or directly to a source line SLi of the panel PANEL. The source driver SOURCE DRIVER may be the driving circuit 110 or the source driver 111 of FIG. 1. In FIG. 2, the source driver SOURCE DRIVER is described as including the switch circuit 202, but the switch circuit 202 may be implemented on the same substrate as the panel (e.g., 120 in FIG. 1).

The amplifier region 201 may be connected to the switch circuit 202 and the DAC 203. The amplifier region 201 may receive an input signal PSi from the DAC 203 and output the data signal S1. The amplifier region 201 may amplify the input signal PSi received from the DAC 203 to generate the data signal S1, and transmit the generated data signal S1 to the panel PANEL through the source line Si. In some embodiments, the amplifier region 201 may operate as a comparator. When the amplifier region 201 operates as the comparator, the amplifier region 201 may receive a detection signal Ri from the source line SLi and the input signal PSi from the DAC 203. The amplifier region 201 may compare the detection signal Ri and the input signal PSi and output an output signal VOi to an output line OLi connected to the driving controller (e.g., 113 in FIG. 1).

The switch circuit 202 may be connected to an output terminal of the amplifier region 201. The switch circuit 202 may electrically connect or disconnect the source line SLi to or from the output terminal of the amplifier region 201 based on a level of a selection signal SEL. For example, when the selection signal SEL is a logic level “H”, the switch circuit 202 may electrically connect the output terminal of amplifier region 201 to the source line SLi, and when the selection signal SEL is a logic level “L”, the switch circuit 202 may disconnect an electrical connection between the output terminal of the amplifier region 201 and the source line SLi.

The DAC 203 may receive the data DATA and convert the data DATA from a digital signal to an analog signal. For example, the DAC 203 may convert the data DATA in a form of a digital signal into an analog signal by matching a plurality of gamma voltages VG1 to VGp received from a gamma voltage generator (not shown) to the data DATA. The converted analog signal may be transmitted to the amplifier region 201 and provided as the input signal PSi to an amplifier provided in the amplifier region 201.

The source line SLi may have a load 210. For example, the source line SLi may have a capacitive load CP. In addition, the source line SLi may have a resistive load and/or an inductive load. A magnitude of the load of the source line SLi may be different from those of other source lines. The amplifier region 201 may output a signal corresponding to the magnitude of the load of the source line SLi by comparing the detection signal Ri and the input signal PSi.

The source line SLi may be shorted with wiring that supplies power voltages ELVSS and ELVDD 220. Additionally, the source line SLi may be shorted with another adjacent source line SL(i+1) 230. In addition, the source line SLi may be shorted with at least one of wirings applying various voltages to signals. The amplifier region 201 may output a signal based on the shorting of the source line SLi, by comparing the detection signal Ri and the input signal PSi.

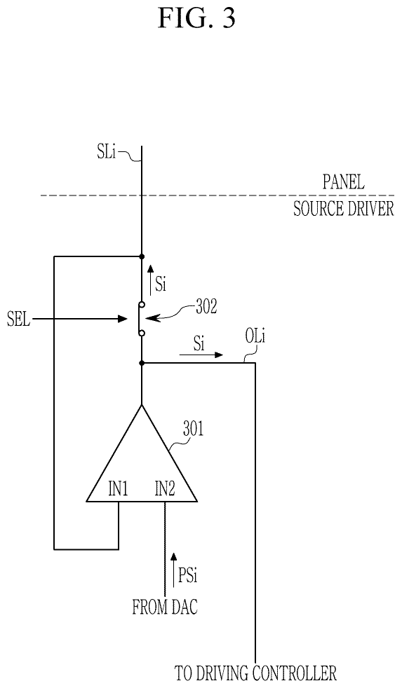

Hereinafter, a method for detecting the load of the source line and/or the occurrence of a short circuit in the source line SLi will be described with reference to FIG. 3 to FIG. 8.

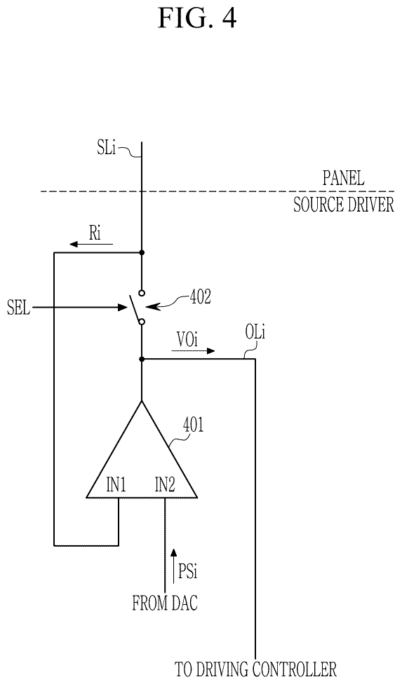

FIG. 3 and FIG. 4 are views illustratively showing a part of a panel and a source driver according to one or more example embodiments.

Referring to FIG. 3, the source driver SOURCE DRIVER may output the data signal S1 to the panel PANEL. The source driver SOURCE DRIVER may include an amplifier 301 and a switch circuit 302.

An output terminal of the amplifier 301 may be connected to the output line OLi. The output terminal of the amplifier 301 may be connected to the source line SLi through the switch circuit 302. An input terminal IN1 of the amplifier 301 may be connected to the source line SLi, and an input terminal IN2 of the amplifier 301 may receive the input signal PSi from the DAC. The amplifier 301 may amplify the input signal PSi and output the data signal S1 to the output terminal of the amplifier 301.

When the selection signal SEL is the logic level “H”, the switch circuit 302 may electrically connect the output terminal of the amplifier 301 to the source line SLi. The data signal S1 from the output terminal of the amplifier 301 may be transmitted to the source line SLi through the switch circuit 302.

Referring to FIG. 4, the source driver SOURCE DRIVER may output a comparison result signal VOi to a driving controller DRIVING CONTROLLER.

An output terminal of the amplifier 401 may be connected to the output line OLi. The output terminal of the amplifier 401 may not be connected to the source line SLi. An input terminal IN1 of the amplifier 401 may be connected to the source line SLi, and an input terminal IN2 of the amplifier 401 may receive the input signal Psi from the DAC. The amplifier 401 may compare the detection signal Ri from the source line SLi and the input signal PSi and output the comparison result signal VOi to the output terminal of the amplifier 401.

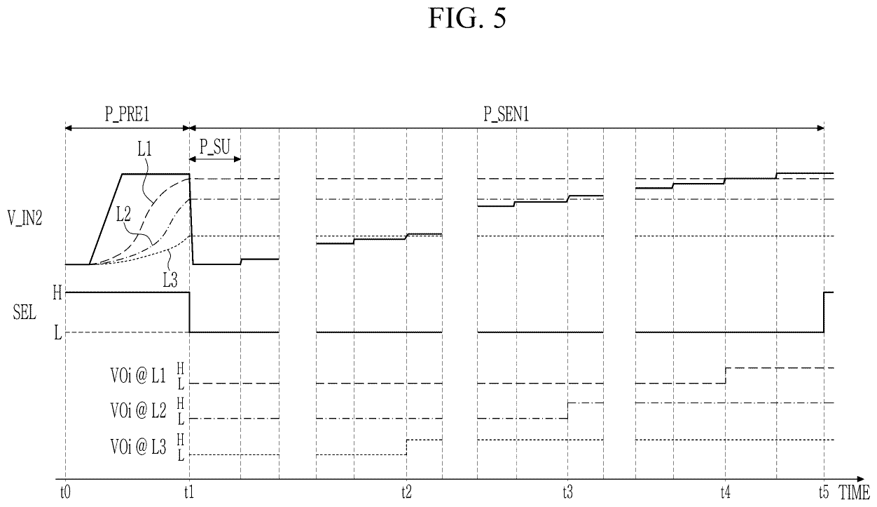

FIG. 5 is a timing diagram of an operation of a source driver determining a characteristic of a source line according to one or more example embodiments.

Specifically, FIG. 5 shows a timing diagram of an operation of determining the magnitude of the load of the source line SLi according to one or more example embodiments. Referring to FIG. 3 to FIG. 5, at a timing to, the input signal Psi may be input to the input terminal IN2 of the amplifier 301. In FIG. 5, V_IN2 indicates a voltage level of the input terminal IN2. A period from t0 to t1 may be a precharge period P_PRE1. During the precharge period P_PRE1, the selection signal SEL may have the logic level “H”. The amplifier 301 may amplify the input signal PSi on the source line SLi and output the amplified input signal Psi as the data signal S1. That is, during the precharge period P_PRE1, the amplifier 301 may output the data signal S1 that charges the source line SLi.

In some embodiments, the precharge period P_PRE1 may be a period of a period 1H (one horizontal period) or less. The voltage of the source line SLi may be changed by the data signal S1 output from the amplifier 301. Depending on the magnitude of the load of the source line SLi, the voltage of the source line SLi may change quickly (e.g., L1) or slowly (e.g., L2 or L3). For example, when the load on the source line SLi is relatively large, the voltage of the source line SLi may change slowly (e.g., L2 or L3). When the load on the source line SLi is relatively small, the voltage on the source line SLi may change quickly (e.g., L1). The precharge period P_PRE1 may be determined based on at least one of a size of the panel PANEL, a length of the source line SLi, or a number of pixels connected to the source line SLi.

At a timing t1, the selection signal SEL may change from the logic level “H” to the logic level “L”. The amplifier 401 may output a signal VOi based on a comparison between the input signal PSi and the detection signal Ri of the source line SLi to the output line OLi. A period from t1 to t5 may be a sensing period P_SEN1. During the sensing period P_SEN1, the level of the input signal PSi may be changed in a range of the plurality of gamma voltages VG1 to VGp. The sensing period P_SEN1 may include a plurality of unit sensing periods P_SU. The input signal PSi may be changed for each of the plurality of unit sensing periods P_SU. For example, the input signal PSi applied to the input terminal IN2 of the amplifier 401 in a first unit sensing period within the sensing period P_SEN1 and the input signal PSi applied to the input terminal IN2 of the amplifier 401 in a second unit sensing period within the sensing period P_SEN1 may be different. The input signal PSi may change as the data DATA applied to the DAC (e.g., 203 in FIG. 2) changes. The driving controller (e.g., 113 in FIG. 1) may change the data DATA, and the DAC 203 may output the input signal PSi corresponding to the changed data DATA. The driving controller 113 may change the data DATA by using various sorting methods such as a binary search. Then, the voltage level of the input signal PSi may also be changed through various sorting methods such as a binary search. For example, when the voltage level of the input signal PSi within the first unit sensing period is a level representing a 128 gray level, the voltage level of the input signal PSi within the second unit sensing period following the first unit sensing period may be a level representing a 64 gray level. Another example, as shown in FIG. 5, when the voltage level of the input signal PSi within the first unit sensing period is a level representing a 0 gray level, the voltage level of the input signal PSi within the second unit sensing period following the first unit sensing period may be a level representing a 1 gray level.

In the unit sensing period P_SU, the amplifier 401 may compare the signals applied to the input terminals IN1 and IN2 and output a comparison result as a comparison result signal VOi. The driving controller 113 may determine the magnitude of the load of the source line SLi based on the data DATA applied to the DAC 203 when the level of the comparison result signal VOi changes.

During a period from t1 to t2, when the load of the source line SLi is from a first magnitude L1 to a third magnitude L3, a level of the input signal PSi is less than a level of the detection signal Ri output from the source line SLi, and the level of the comparison result signal VOi may be a logic “L” level. At a timing t2, the level of the input signal PSi is greater than the level of the detection signal Ri output from the source line SLi whose the load is the third magnitude L3, and the level of the comparison result signal VOi for the source line SLi whose the load is the third magnitude L3 may transition from the logic “L” level to the logic “H” level. Based on the data DATA that the driving controller 113 applies to the DAC 203 when the level of the comparison result signal VOi of the source line SLi transitions from the logic “L” level to the logic “H” level, the driving controller 113 may determine the magnitude of the load of the source line SLi. At this time, the magnitude of the load of source line SLi may be related to data DATA and may correspond to the third magnitude L3.

During a period from t2 to t3, when the load of the source line SLi is from the first magnitude L1 to a second magnitude L2, a level of the input signal PSi is less than a level of the detection signal Ri output from the source line SLi, and the level of the comparison result signal VOi may be the logic “L” level. At a timing t3, the level of the input signal PSi is greater than the level of the detection signal Ri output from the source line SLi whose the load is the second magnitude L2, and the level of the comparison result signal VOi for the source line SLi whose the load is the second magnitude L2 may transition from the logic “L” level to the logic “H” level. Based on the data DATA applied by the driving controller 113 to the DAC 203 when the level of the comparison result signal VOi of the source line SLi transitions from the logic “L” level to the logic “H” level, the driving controller 113 may determine the magnitude of the load of the source line SLi. At this time, the magnitude of the load of the source line SLi is related to the data DATA and may correspond to the second magnitude L2.

During a period from t3 to t4, when the load of the source line SLi is the first magnitude L1, a level of the input signal PSi is less than a level of the detection signal Ri output from the source line SLi, and the level of the comparison result signal VOi may be the logic “L” level. At a timing t4, the level of the input signal PSi is greater than the level of the detection signal Ri output from the source line SLi whose the load is the first magnitude L1, and the level of the comparison result signal VOi for the source line SLi whose the load is the first magnitude L1 may transition from the logic “L” level to the logic “H” level. Based on the data DATA applied by the driving controller 113 to the DAC 203 when the level of the comparison result signal VOi of the source line SLi transitions from the logic “L” level to the logic “H” level, the driving controller 113 may determine the magnitude of the load of the source line SLi. At this time, the magnitude of the load of the source line SLi may be related to data DATA and may correspond to the first magnitude L1.

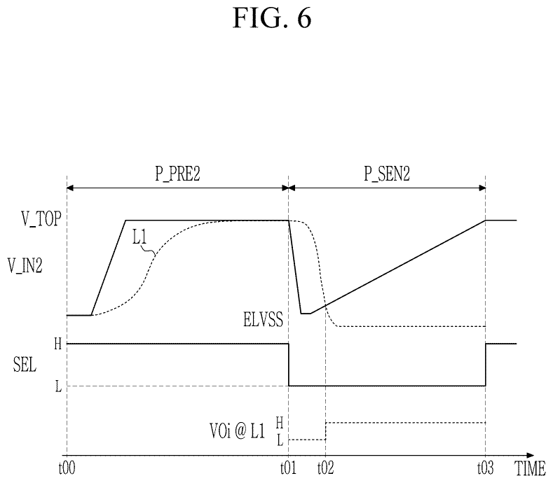

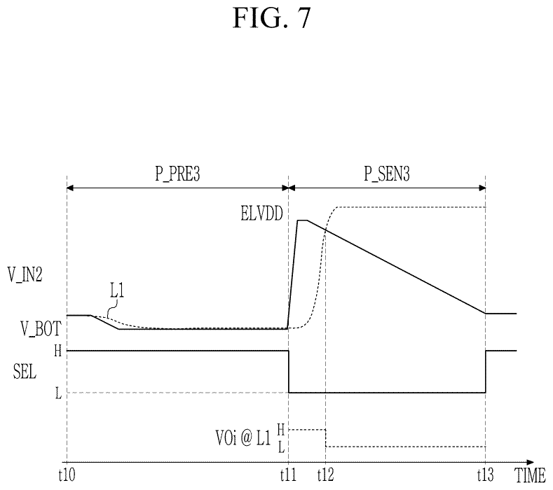

FIG. 6 and FIG. 7 are timing diagrams of an operation of determining a defect in a source line by a source driver according to one or more example embodiments.

Specifically, FIG. 6 shows a timing diagram of an operation of determining a short circuit between the source line SLi and a wiring that provides a first power voltage ELVSS. FIG. 7 shows a timing diagram of an operation of determining a short circuit between the source line SLi and a wiring that provides a second power voltage ELVDD.

Referring to FIG. 3, FIG. 4, and FIG. 6, at a timing t00, the input signal PSi may be input to the input terminal IN2 of the amplifier 301. In FIG. 6, V_IN2 indicates the voltage level of the input terminal IN2. A period from 100 to t01 may be a precharge period P_PRE2. During the precharge period P_PRE2, the selection signal SEL may have the logic level “H”. The amplifier 301 may amplify the input signal PSi on the source line SLi to be output as the data signal S1. That is, during the precharge period P_PRE2, the amplifier 301 may output the data signal S1 that charges the source line SLi. In some embodiments, the data signal S1 may be a highest voltage V_TOP among a plurality of gamma voltages VG1, VG2, . . . , VGp.

In some embodiments, the precharge period P_PRE2 may be a period of 2H periods (two horizontal periods) or longer. The precharge period P_PRE2 may be a period long enough for the voltage of the source line SLi to reach the voltage V_TOP of the data signal S1. During the precharge period P_PRE2, the voltage of the source line SLi corresponding to the magnitude L1 of the load may reach the voltage V_TOP.

At a timing t01, the selection signal SEL may change from the logic level “H” to the logic level “L”. The amplifier 401 may output the signal VOi to the output line OLi based on comparison between the input signal PSi and the detection signal Ri of the source line SLi. A period from t01 to t03 may be a sensing period P_SEN2. During the sensing period P_SEN2, the level of the input signal PSi may be changed in the range of the plurality of gamma voltages VG1 to VGp. In some embodiments, the level of the input signal PSi during the sensing period P_SEN2 may decrease from the voltage V_TOP to a voltage V_BOT, which is a lowest voltage among the plurality of gamma voltages VG1, VG2, . . . , VGp. Like the sensing period P_SEN1 in FIG. 5, the sensing period P_SEN2 may include a plurality of unit sensing periods P_SU. The description of the sensing period P_SEN2 may be the same or similar to the description of the sensing period P_SEN1 in FIG. 5, the description thereof is omitted.

During a period from t01 to t02, since a level of the input signal PSi is less than a level of the detection signal Ri output from the source line SLi, the level of the comparison result signal VOi may be the logic “L” level. At a timing t02, since the level of the input signal PSi becomes greater than the level of the detection signal Ri output from the source line SLi, the level of the comparison result signal VOi for the source line SLi may transition from the logic “L” level to the logic “H” level. Based on the data DATA applied by the driving controller 113 to the DAC 203 when the level of the comparison result signal VOi of the source line SLi transitions from the logic “L” level to the logic “H” level, the driving controller 113 may determine that the source line SLi is short-circuited with the wiring that provides first power voltage ELVSS. For example, when the voltage level of the input signal PSi at the timing t02 has a relatively small difference from a level of the first power voltage ELVSS, the driving controller 113 may determine that the short circuit has occurred in the source line SLi with the wiring that provides the first power voltage ELVSS. If the source line SLi is not shorted with the wiring that provides the first power voltage ELVSS, the voltage level of the input signal PSi will have a relatively small difference from the level of the voltage V_TOP.

Referring to FIG. 3, FIG. 4, and FIG. 7, at a timing t10, the input signal PSi may be input to the input terminal IN2 of the amplifier 301. In FIG. 7, V_IN2 indicates the voltage level of the input terminal IN2. A period from t10 to t11 may be a precharge period P_PRE3. During the precharge period P_PRE3, the selection signal SEL may have the logic level “H”. The amplifier 301 may amplify the input signal PSi on the source line SLi to be output as a data signal S1. That is, during the precharge period P_PRE3, the amplifier 301 may output the data signal S1 that charges the source line SLi. In some embodiments, the data signal S1 may be a lowest voltage V_BOT among the plurality of gamma voltages VG1, VG2, . . . , VGp.

In some embodiments, the precharge period P_PRE3 may be a period of 2H periods or longer. The precharge period P_PRE3 may be a period long enough for the voltage of the source line SLi to reach the voltage V_BOT of the data signal S1. During the precharge period P_PRE3, the voltage of the source line SLi corresponding to the magnitude L1 of the load may reach the voltage V_BOT.

At a timing t11, the selection signal SEL may change from the logic level “H” to the logic level “L”. The amplifier 401 may output the signal VOi to the output line OLi based on comparison between the input signal PSi and the detection signal Ri of the source line SLi. A period from t11 to t13 may be a sensing period P_SEN3. During the sensing period P_SEN3, the level of the input signal PSi may be changed in the range of the plurality of gamma voltages VG1 to VGp. In some embodiments, the level of the input signal PSi during the sensing period P_SEN3 may decrease from the voltage V_TOP to the voltage V_BOT. Like the sensing period P_SEN1 in FIG. 5, the sensing period P_SEN3 may include a plurality of unit sensing periods P_SU. The description of the sensing period P_SEN3 may be the same or similar to the description of the sensing period P_SEN1 in FIG. 5 and thus the description thereof is omitted.

During a period from t11 to t12, since the input signal PSi is greater than the detection signal Ri output from the source line SLi, the level of the comparison result signal VOi may have the logic “H” level. At a timing t12, since a level of the input signal PSi becomes less than a level of the detection signal Ri output from the source line SLi, the level of the comparison result signal VOi for the source line SLi may transition from the logic “H” level to the logic “L” level. Based on the data DATA applied by the driving controller 113 to the DAC 203 when the level of the comparison result signal VOi of the source line SLi transitions from the logic “H” level to the logic “L” level, the driving controller 113 may determine that the source line SLi is shorted with the wiring that provides the second power voltage ELVDD. For example, if the voltage level of the input signal PSi at the timing t12 has a relatively small difference from the level of the second power voltage ELVDD, the driving controller 113 may determine that the source line SLi is short-circuited with the wiring that provides the second power voltage ELVDD. If the source line SLi is not short-circuited with the wiring that provides the second power voltage ELVDD, the voltage level of the input signal PSi may have a relatively small difference from the level of the voltage V_BOT.

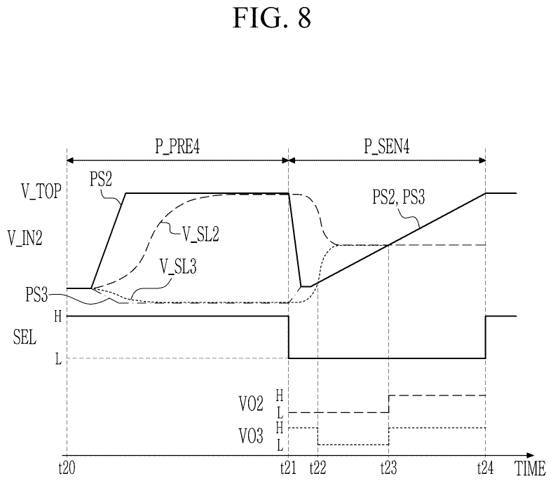

FIG. 8 is a timing diagram of an operation of a source driver determining defects in source lines according to one or more example embodiments.

Specifically, FIG. 8 shows a timing diagram of an operation of determining the short circuit between a source line SL2 and an adjacent source line SL3.

Referring to FIG. 3, FIG. 4, and FIG. 8, at a timing t20, the input signal Psi may be input to the input terminal IN2 of each amplifier 301 of the source line SL2 and the source line SL3. In FIG. 8, V_IN2 indicates the voltage level of the input terminal IN2. A period from t20 to t21 may be a precharge period P_PRE4. During the precharge period P_PRE4, the selection signal SEL may have the logic level “H”. The amplifier 301 may amplify input signals PS2 and PS3 on the corresponding source lines SL2 and SL3 and output the amplified input signals as the data signals. That is, during the precharge period P_PRE4, the amplifier 301 may output the data signal that charges the corresponding source lines SL2 and SL3. In some embodiments, data signals S2 and S3 applied to two adjacent source lines SL2 and SL3 may be different from each other. For example, the data signal S2 applied to the source line SL2 may be a highest voltage V_TOP among the plurality of gamma voltages VG1, VG2, . . . , VGp, and the data signal S3 applied to the source line SL3 may be a lowest voltage V_BOT among the plurality of gamma voltage VG1, VG2, . . . , VGp.

In some embodiments, the precharge period P_PRE4 may be a period of 2H periods or longer. The precharge period P_PRE4 may be a period long enough for the voltages of the source lines SL2, and SL3 to reach the voltages V_TOP and V_BOT of the data signals S2 and S3, respectively. During the precharge period P_PRE4, a voltage V_SL2 of the source line SL2 may reach the voltage V_TOP, and a voltage V_SL3 of the source line SL3 may reach the voltage V_BOT. When the precharge period P_PRE4 ends, the voltages of the source lines SL2 and SL3 may become the same due to a shorting between the source lines SL2 and SL3. That is, the voltage of the source lines SL2 and SL3 may have a voltage level between the voltage V_TOP and the voltage V_BOT.

At a timing t21, the selection signal SEL may change from the logic level “H” to the logic level “L”. The amplifier 401 connected to the source line SL2 may output a signal VO2 to an output line OL2 by comparing the input signal PS2 and a detection signal R2 of the source line SL2. The amplifier 401 connected to the source line SL3 may output a signal VO3 to an output line OL3 by comparing the input signal PS3 and a detection signal R3 of source line SL3. A period from t21 to t23 may be a sensing period P_SEN4. During the sensing period P_SEN4, levels of the input signals PS2 and PS3 may be changed in the range of the plurality of gamma voltages VG1 to VGp. In some embodiments, the levels of the input signals PS2 and PS3 may decrease from the voltage V_TOP to the voltage V_BOT during the sensing period P_SEN4. Like the sensing period P_SEN1 in FIG. 5, the sensing period P_SEN4 may include a plurality of unit sensing periods P_SU. The description of the sensing period P_SEN4 may be the same or similar to the description of the sensing period P_SEN1 in FIG. 5 and thus the description thereof is omitted.

During a period from t21 to t22, since a level of the input signal PS2 is less than a level of the detection signal R2 output from the source line SL2, the level of the comparison result signal VO2 may have the logic “L” level. Since a level of the input signal PS3 is greater than a level of the detection signal R3 output from the source line SL3, the level of the comparison result signal VO3 may have the logic “H” level. At a timing t22, since a level of the input signal PS3 is less than a level of the detection signal R3 output from source line SL3, the level of the comparison result signal VO3 for the source line SL3 may transition from the logic “H” level to the logic “L” level. At a timing t23, since the level of the input signal PS2 is greater than the level of the detection signal R2 output from source line SL2, the level of the comparison result signal VO2 for the source line SL2 may transition from the logic “L” level to the logic “H” level. Likewise, since the level of the input signal PS3 is greater than the level of the detection signal R3 output from the source line SL3, the level of the comparison result signal VO3 for the source line SL3 may transition from the logic “L” level to the logic “H” level.

That is, at a timing t23, since the levels of the comparison result signals VO2 and VO3 of the two source lines SL2 and SL3 have transitioned, the driving controller 113 may determine that two source lines SL2 and SL3 charged with the different voltages V_TOP and V_BOT are short-circuited and have the same voltage level.

As explained in FIG. 5 to FIG. 8, the source driver according to one or more example embodiments may measure the magnitude of the load of the source line and detect the short circuit defects between the source line and other wiring(s).

The source driver according to one or more example embodiments, as shown in FIG. 5, may determine a magnitude of the load of four source lines SLi, . . . , SLi+3 by precharging four adjacent source lines SLi, . . . , SLi+3 with an arbitrary data voltage. The source driver according to one or more example embodiments, as shown in FIG. 6, may detect the short circuit with other voltage wiring by precharging four adjacent source lines SLi, . . . , SLi+3 with the relatively high voltage V_TOP,

The source driver according to one or more example embodiments as shown in FIG. 7, may detect the short circuit with other voltage wiring of the four source lines SLi, . . . , SLi+3 by precharging four adjacent source lines SLi, . . . , SLi+3 with the relatively low voltage V_BOT. The source driver according to one or more example embodiments, as shown in FIG. 8, may detect the short circuit between four adjacent source lines SLi, . . . , SLi+3 by precharging four adjacent source lines SLi, . . . , SLi+3 with the different voltages.

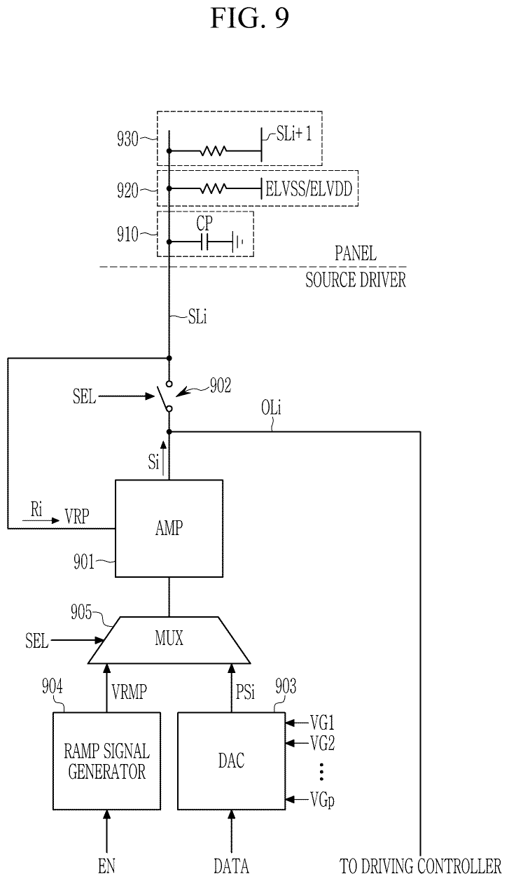

FIG. 9 is a block diagram showing part of a panel and a source driver according to one or more example embodiments.

Referring to FIG. 9, the source driver SOURCE DRIVER may include an amplifier region 901, a first switch circuit 902, a digital-to-analog converter (DAC) 903, a lamp signal generator 904, a multiplexer circuit 905. The source driver SOURCE DRIVER may be connected electrically and/or directly to the source line SLi of the panel PANEL. The source driver SOURCE DRIVER may be the driving circuit 110 or the source driver 111 of FIG. 1. In FIG. 9, the source driver SOURCE DRIVER is described as including the switch circuit 902, but the switch circuit 902 may be formed on the same substrate as the panel (e.g., 120 of FIG. 1). Among the components of FIG. 9, the description of the components that are the same or similar to those in FIG. 2 will be omitted.

The amplifier region 901 may be connected to the switch circuit 902 and the multiplexer circuit 905. The amplifier region 901 may receive the input signal PSi from the DAC 903 through the multiplexer circuit 905 and output the data signal Si. The amplifier region 901 may amplify the input signal PSi received from the DAC 903 to generate the data signal S1, and may transmit the generated data signal S1 to the panel PANEL through the source line Si. In some embodiments, the amplifier region 901 may operate as a comparator. When the amplifier region 901 operates as the comparator, the amplifier region 901 may receive the detection signal Ri from the source line SLi and a lamp signal VRMP from the lamp signal generator 904 through the multiplexer circuit 905. The amplifier region 901 may compare the detection signal Ri and the lamp signal VRMP and output an output signal VOi to the output line OLi connected to the driving controller (e.g., 113 in FIG. 1).

The switch circuit 902 may be connected to an output terminal of the amplifier region 901. The switch circuit 902 may electrically connect or disconnect the source line SLi to or from the output terminal of the amplifier region 901 depending on a level of a first selection signal SEL.

The DAC 903 may receive the data DATA and convert the data DATA from a digital signal to an analog signal.

The lamp signal generator 904 may generate the lamp signal VRMP. For example, the lamp signal generator 904 may generate the lamp signal VRMP that increases with a constant slope or the lamp signal VRMP that decreases with a constant slope. The lamp signal generator 904 may operate based on a lamp control signal EN provided from the driving controller 113. The lamp signal generator 904 may generate the lamp signal VRMP when the lamp control signal EN is activated.

The multiplexer circuit 905 may be connected to an input terminal of the amplifier region 901. The multiplexer circuit 905 may electrically connect the DAC 903 and the input terminal of the amplifier region 901, or the lamp signal generator 904 and the input terminal of the amplifier region 901, depending on a level of a second selection signal SEL.

The source line SLi may have a load 910. For example, the source line SLi may have a capacitive load CP. The source line SLi may be shorted with a wiring that supplies a power voltage ELVSS, ELVDD 920. Additionally, the source line SLi may be shorted with another adjacent source line SL(i+1) 930.

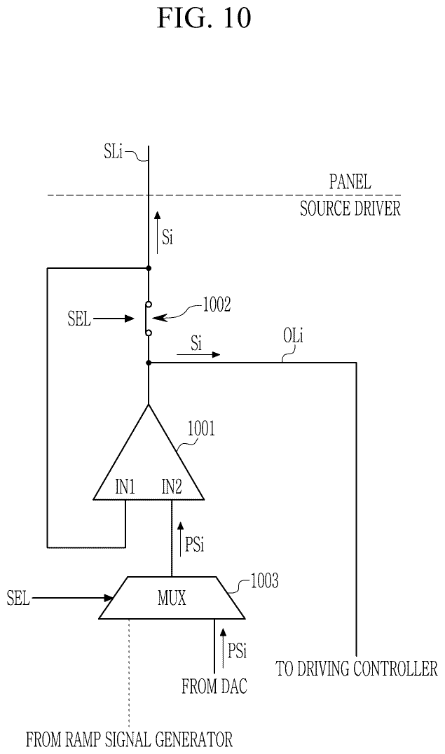

Below, a method for detecting the load of the source line SLi and/or the occurrence of a short circuit in the source line SLi will be described with reference to FIG. 10 to FIG. 12.

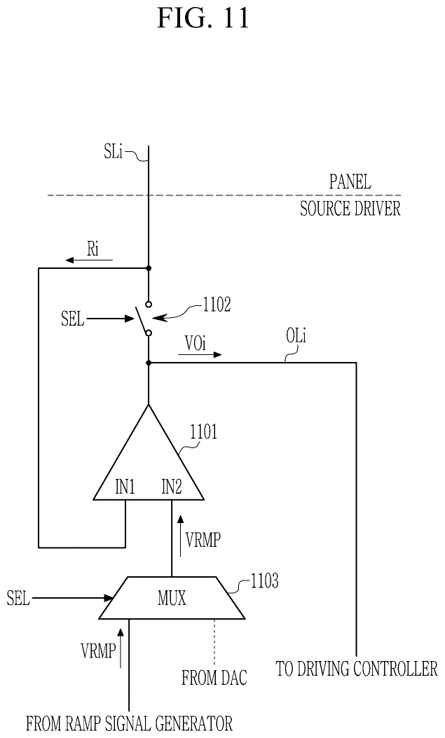

FIG. 10 and FIG. 11 are views that illustratively show a part of a panel and a source driver according to one or more example embodiments.

Referring to FIG. 10, a source driver SOURCE DRIVER may output a data signal S1 to a panel PANEL. The source driver SOURCE DRIVER may include an amplifier 1001 and a switch circuit 1002.

An output terminal of the amplifier 1001 may be connected to the output line OLi. The output terminal of the amplifier 1001 may be connected to the source line SLi through the switch circuit 1002. An input terminal IN1 of the amplifier 1001 may be connected to the source line SLi, and an input terminal IN2 of the amplifier 1001 may be connected to an output terminal of the multiplexer circuit 1003. The amplifier 1001 may amplify the input signal PSi and output the data signal Si to the output terminal of the amplifier 1001.

In the switch circuit 1002, when the first selection signal SEL is a logic level “H”, the output terminal of amplifier 1001 may be electrically connected to the source line SLi. The switch circuit 1002 may receive the data signal S1 from the output terminal of the amplifier 1001 and transmit the data signal S1 to the source line SLi.

In the multiplexer circuit 1003, when the second selection signal SEL is a logic level “H”, the input terminal IN2 of the amplifier 1001 may be electrically connected to the output terminal of the DAC. The multiplexer circuit 1003 may receive the input signal PSi from the DAC and transmit the input signal PSi to the input terminal IN2 of the amplifier 1001.

Referring to FIG. 11, the source driver SOURCE DRIVER may output the comparison result signal VOi to the driving controller DRIVING CONTROLLER.

The output terminal of the amplifier 1101 may be connected to the output line OLi. The output terminal of the amplifier 1101 may not be connected to the source line SLi. The input terminal IN1 of the amplifier 1101 may be connected to the source line SLi, and the input terminal IN2 of the amplifier 1001 may be connected to an output terminal of the multiplexer circuit 1103. The amplifier 1101 may compare the detection signal Ri from the source line SLi and the lamp signal VRMP and output the comparison result signal VOi to the output terminal of the amplifier 1101.

When the second selection signal SEL is a logic level “L”, the multiplexer circuit 1103 may electrically connect the input terminal IN2 of the amplifier 1101 to the output terminal of the lamp signal generator. The multiplexer circuit 1103 may receive the lamp signal VRMP from the lamp signal generator and transmit the lamp signal VRMP to the input terminal IN2 of the amplifier 1101.

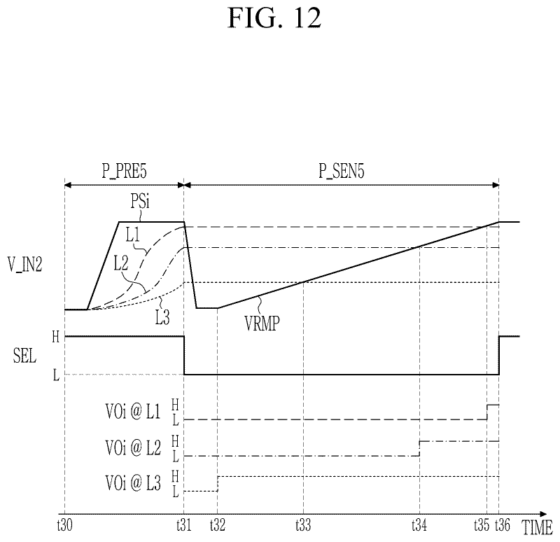

FIG. 12 is a timing diagram of an operation of determining a characteristic of a source line by a source driver according to one or more example embodiments.

Specifically, FIG. 12 shows a timing diagram of an operation of determining the magnitude of the load of the source line SLi. Referring to FIG. 10 to FIG. 12, at a timing t30, the input signal PSi may be input to the input terminal IN2 of the amplifier 1001. In FIG. 12, V_IN2 indicates the voltage level of the input terminal IN2. A period from t30 to t31 may be a precharge period P_PRE5. During the precharge period P_PRE5, the first selection signal SEL may have a logic level “H”. The amplifier 1001 may amplify the input signal PSi on the source line SLi to be output as a data signal S1. That is, during the precharge period P_PRE5, the amplifier 1001 may output the data signal S1 that charges the source line SLi.

In some embodiments, the precharge period P_PRE5 may be a period of 1H period or less. The voltage of the source line SLi may be changed by the data signal S1 output by the amplifier 1001. Depending on the magnitude of the load of the source line SLi, the voltage of the source line SLi may change quickly (e.g., L1) or slowly (e.g., L2 or L3). For example, when the load on the source line SLi is relatively large, the voltage on the source line SLi may change slowly (e.g., L2 or L3). When the load on the source line SLi is relatively small, the voltage on the source line SLi may change quickly (e.g., L1). The precharge period P_PRE5 may be determined based on at least one of the size of the panel PANEL, the length of the source line SLi, or the number of the pixels connected to the source line SLi.

At a timing t31, the first selection signal SEL may change from the logic level “H” to the logic level “L”. The amplifier 1101 may output a signal VOi to the output line OLi based on comparison between the lamp signal VRMP and the detection signal Ri of the source line SLi. A period from t31 to t36 may be a sensing period P_SEN5. During a period from t32 to t36, the level of the lamp signal VRMP may increase with a constant slope.

The amplifier 1101 may output the result of comparing signals applied to input terminals IN1 and IN2 as the comparison result signal VOi. The driving controller 113 may count the comparison result signal VOi based on a clock signal and determine the magnitude of the load of the source line SLi based on the counting result.

During a period from t31 to t33, when the load of the source line SLi is from a first magnitude L1 to a third magnitude L3, since a level of the lamp signal VRMP is less than a level of the detection signal Ri output from the source line SLi, the level of the comparison result signal VOi may have a logic “L” level. At a timing t33, since the level of the lamp signal VRMP becomes greater than the level of the detection signal Ri output from the source line SLi whose the load is the third magnitude L3, the level of the comparison result signal VOi for the source line SLi where the load is the third magnitude L3 may transition from the logic “L” level to the logic “H” level. The driving controller 113 may count the timing at which the level of the comparison result signal VOi transitions from the logic “L” level to the logic “H” level, and determine the magnitude of the load of the source line SLi based on the counting result. At this time, the magnitude of the load of the source line SLi may be related to the period between t32 and t33.

During the period of t33 to t34, when the load of the source line SLi is from the first magnitude L1 to the second magnitude L2, since a level of the lamp signal VRMP is less than a level of the detection signal Ri output from the source line SLi, the level of the comparison result signal VOi may be a logic “L” level. At a timing t34, since the level of the lamp signal VRMP becomes greater than the level of the detection signal Ri output from the source line SLi with the load of the second magnitude L2, the level of the comparison result signal VOi for the source line SLi with the load of the second magnitude L2 may transition from the logic “L” level to the logic “H” level. The driving controller 113 may count the timing at which the level of the comparison result signal VOi transitions from the logic “L” level to the logic “H” level, and determine the magnitude of the load of the source line SLi based on the counting result. At this time, the magnitude of the load of the source line SLi may be related to the period between t33 and t34.

During a period from t34 to t35, when the load of the source line SLi is the first magnitude L1, a level of the lamp signal VRMP is less than a level of the detection signal Ri output from the source line SLi, and the level of the comparison result signal VOi may have the logic “L” level. At a timing t35, since the level of lamp signal VRMP is greater than the level of the detection signal Ri output from the source line SLi whose the load is the first magnitude L1, the level of the comparison result signal VOi for the source line SLi whose the load is the first magnitude L1 may transition from the logic “L” level to the logic “H” level. The driving controller 113 may count the timing at which the level of the comparison result signal VOi transitions from the logic “L” level to the logic “H” level, and determine the magnitude of the load of the source line SLi based on the counting result. At this time, the magnitude of the load of the source line SLi may be related to the period between t34 and t35. At the timing t36, the first selection signal SEL may change from the logic level “L” to the logic level “H”.

The source driver of one or more example embodiments may include the lamp signal generator 904 that generates the lamp signal VRMP, and the magnitude of the load of the source line SLi may be determined using the lamp signal VRMP. In addition, the source driver may detect the defects in the source line SLi by using the lamp signal VRMP in a manner the same as or similar to that of the input signal Psi of FIG. 6 to FIG. 8. Thus, the same as or similar to the description in FIG. 6 to FIG. 8, and FIG. 12 may be applicable and repetitive description is omitted.

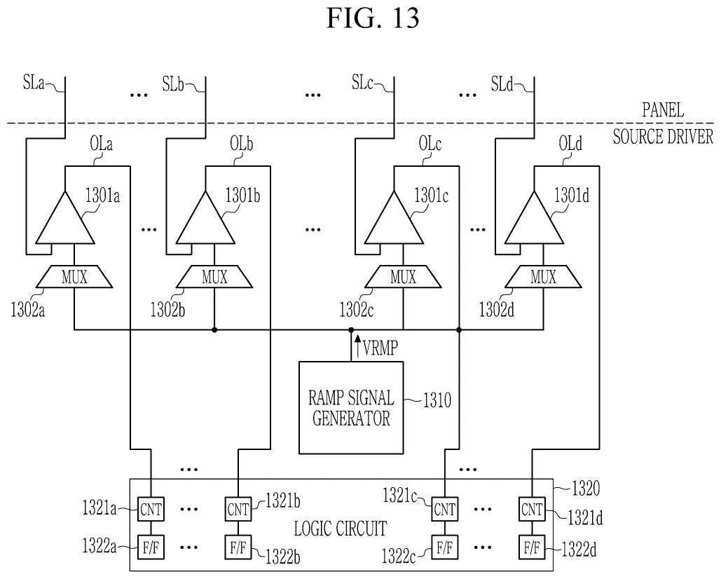

FIG. 13 is a block diagram showing a relationship between a plurality of source lines and a source driver of a panel according to one or more example embodiments.

As shown in FIG. 13, each of a plurality of amplifiers 1301a, 1301b, 1301c, and 1301d may include a first input terminal connected to a corresponding source line among a plurality of source lines Sla, SLb, SLc, and SLd extended from the panel, a second input terminal connected to an output terminal of a corresponding multiplexer circuit among a plurality of multiplexer circuits 1302a, 1302b, 1302c, and 1302d, and an output terminal connected to a corresponding output line among a plurality of output lines Ola, OLb, OLc, and Old.

The input terminals of the plurality of multiplexer circuits 1302a, 1302b, 1302c, and 1302d may be connected to an output terminal of the lamp signal generator 1310. The lamp signal generator 1310 may generate a lamp signal VRMP and output the lamp signal VRMP to the plurality of multiplexer circuits 1302a, 1302b, 1302c, and 1302d.

A logic circuit 1320 may include a plurality of counter circuits 1321a, 1321b, 1321c, and 1321d and a plurality of flip-flops 1322a, 1322b, 1322c, and 1322d. The plurality of counter circuits 1321a, 1321b, 1321c, and 1321d may be respectively connected to the plurality of output lines Ola, OLb, OLc, and Old, receive a plurality of comparison result signals, and output a result of counting a timing at which levels of the plurality of comparison result signals transition. The plurality of flip-flops 1322a, 1322b, 1322c, and 1322d may store the counting results output from the plurality of counter circuits 1321a, 1321b, 1321c, and 1321d.

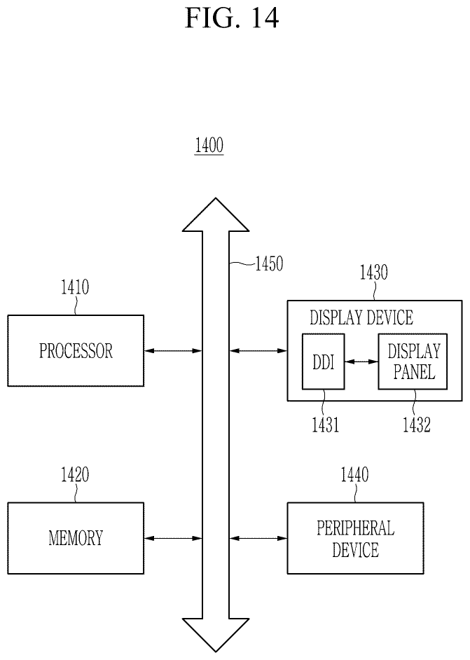

FIG. 14 is a view to explain a display system according to one or more example embodiments.

Referring to FIG. 14, a display system 1400 according to one or more example embodiments may include a processor 1410, a memory 1420, a display device 1430, and a peripheral device 1440 that are electrically connected to a system bus 1450.

The processor 1410 may control an input/output of a data of the memory 1420, the display device 1430, and the peripheral device 1440, and perform an image processing of an image data transmitted between corresponding devices.

The memory 1420 may include a volatile memory such as, for example, a dynamic random access memory (DRAM) and/or a non-volatile memory such as, for example, a flash memory. The memory 1420 may include, for example but not limited to, a DRAM, a phase-change random access memory (PRAM), a magnetic random access memory (MRAM), a resistive random access memory (ReRAM), a ferroelectric random access memory (FRAM), a NOR flash memory, a NAND flash memory, and a fusion flash memory (for example, a memory that combines a static random access memory (SRAM) buffer, a NAND flash memory, and an NOR interface logic). The memory 1420 may store an image data obtained from the peripheral device 1440 or a video signal processed by the processor 1410.

The display device 1430 may include a display driver integrated circuit (DDI) 1431 and a display panel 1432, and store an image data applied through the system bus 1450 in a frame memory included within the DDI 1431 to be displayed on the panel 1432. The DDI 1431 may include a source driver according to one or more example embodiments. The DDI 1431 may detect the load and/or defect in the source line of the display panel 1432. By using the amplifier that applies the data signal to the source line as the comparator, the DDI 1431 may detect the load and/or defect in the source line based on the changes in the voltage charged to the source line. A display driving device according to one or more example embodiments may correspond to the DDI 1431.

The peripheral device 1440 may be a device that converts a motion picture or a still image into an electrical signal, such as a camera, scanner, or webcam. The image data acquired through the peripheral device 1440 may be stored in the memory 1420 or displayed on the panel 1432 in real-time.

The display system 1400 may be provided in a mobile electron product such as a smart phone, but is not limited thereto, and may be provided in various types of electron products that display images.

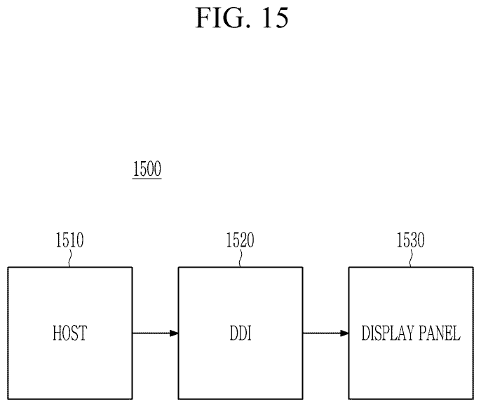

FIG. 15 is a view to explain a display system according to one or more example embodiments.

Referring to FIG. 15, a display system 1500 according to one or more example embodiments may include a host 1510, a DDI 1520, and a display panel 1530.

The host 1510 may receive data or instructions from a user and control the DDI 1520 based on the received data or instructions. The DDI 1520 may drive the display panel 1530 under the control of the host 1510. The DDI 1520 may include a semiconductor device according to one or more example embodiments. The DDI 1520 may include an amplifier region that operates selectively as a source driver that transmits the data signal to the display panel 1530 to display the image data or operates selectively as a comparator that receives the detection signal from the display panel 1530 according to the load and/or defect of the source line.

In some embodiments, each component or combinations of two or more components described with reference to FIG. 1 to FIG. 15 may be implemented as a digital circuit, a programmable or non-programmable logic device or array, an application specific integrated circuit (ASIC), or the like.

While this disclosure has been described in connection with example embodiments, it is to be understood that the disclosure is not limited to the described example embodiments, but, on the contrary, covers various modifications and equivalent arrangements included within the spirit and scope of the appended claims and their equivalents.

What is claimed is:

1. A display driving device comprising:
a source driver configured to output a data signal obtained by amplifying an input signal to a source line in a first period, and, in a second period different from the first period, receive a detection signal from the source line and output a comparison result signal based on a comparison between the detection signal and the input signal; and
a driving controller configured to determine a characteristic of the source line based on a timing at which a level of the comparison result signal transitions in the second period.

2. The display driving device of claim 1, wherein the source driver comprises:
a digital-to-analog converter configured to output the input signal based on data received from the driving controller, and
an amplifier region comprising an amplifier, the amplifier region being configured to amplify the input signal to output the data signal in the first period, and compare the input signal and the detection signal to output the comparison result signal in the second period.

3. The display driving device of claim 2, wherein the first period is a period of one horizontal period or less.

4. The display driving device of claim 3, wherein the driving controller is further configured to change the data multiple times in the second period, and determine a magnitude of a load of the source line based on data, among the data changed multiple times, related to the timing at which the level of the comparison result signal transitions in the second period.

5. The display driving device of claim 2, wherein the first period is a period of two horizontal periods or greater.

6. The display driving device of claim 5, wherein the driving controller is further configured to change the data multiple times in the second period, and detect a defect in the source line based on data, period among the data changed multiple times, related to the timing at which the level of the comparison result signal transitions in the second period.

7. The display driving device of claim 5, wherein the source driver is further configured to output a first data signal obtained by amplifying a first input signal to a first source line adjacent to the source line in the first period, the first input signal being different from the input signal, and in the second period, receive a first detection signal from the first source line and output a first comparison result signal by comparing the first detection signal and the first input signal, and
wherein the driving controller is further configured to detect a short between the source line and the first source line based on the comparison result signal and the first comparison result signal.

8. The display driving device of claim 2, wherein the source driver further includes a lamp signal generator configured to provide a lamp signal that increases or decreases with a constant slope as the input signal in the second period.

9. The display driving device of claim 8, wherein the driving controller is further configured to count the timing at which the level of the comparison result signal transitions based on a clock signal and determine the characteristic of the source line based on a result of counting.

10. The display driving device of claim 8, wherein the source driver further includes a multiplexer circuit configured to, based on a level of a selection signal, selectively connect an input terminal of the amplifier region to the digital-to-analog converter in the first period and selectively connect the input terminal of the amplifier region to the lamp signal generator in the second period.

11. The display driving device of claim 2, wherein the source driver further includes a switch circuit configured to, based on a level of a selection signal, selectively connect an output terminal of the amplifier region to the source line in the first period and disconnect the output terminal of the amplifier region from the source line in the second period.

12. A display device comprising:
a panel including a plurality of pixels and a plurality of source lines connected to the plurality of pixels; and
a display driving circuit including an amplifier region and a driving controller, the amplifier region comprising an amplifier and being configured to transmit a plurality of data signals to the plurality of source lines in a first period, and in a second period different from the first period, receive a plurality of detection signals from the plurality of source lines and output a plurality of comparison result signals by comparing the plurality of detection signals and an input signal, and the driving controller being configured to determine characteristics of the plurality of source lines based on the plurality of comparison result signals, respectively.

13. The display device of claim 12, wherein the display driving circuit further includes a gamma voltage generator configured to output the input signal in the second period.

14. The display device of claim 13, wherein the gamma voltage generator is further configured to change a level of the input signal in the second period.

15. The display device of claim 12, wherein the display driving circuit further includes a lamp signal generator configured to provide a lamp signal that increases or decreases with a constant slope as the input signal in the second period.

16. The display device of claim 12, wherein the amplifier region is further configured to, in the first period, transmit a data signal of a first level to a first data line among a plurality of data lines, and a data signal of a second level different from the first level to a second data line adjacent to the first data line among the plurality of data lines.

17. The display device of claim 12, wherein the first period is a period of one horizontal period or less, and the driving controller is further configured to determine a magnitude of a load of a corresponding source line.

18. The display device of claim 12, wherein the first period is a period of two horizontal periods or greater, and the driving controller is further configured to determine a short defect of a corresponding source line.

19. A source driver comprising:
a digital-to-analog converter configured to output an input signal based on input data;
an amplifier region including an amplifier, the amplifier region being configured to amplify the input signal to output a data signal in a first period, and in a second period after the first period, compare the input signal and a detection signal received from a source line to output a comparison result signal; and
a switch circuit configured to, based on a level of a first selection signal, selectively connect an output terminal of the amplifier region to the source line in the first period and selectively disconnect the output terminal of the amplifier region from the source line in the second period.

20. The source driver of claim 19, further comprising:
a lamp signal generator configured to provide a lamp signal that increases or decreases with a constant slope as the input signal in the second period, and
a multiplexer circuit configured to, based on a level of a second selection signal, selectively connect an input terminal of the amplifier region to the digital-to-analog converter in the first period and selectively connect the input terminal of the amplifier region to the lamp signal generator in the second period.
